(19) United States
(12) Patent Application Publication
(10) Pub. No.: US 2009/0097534 A1
(43) Pub. Date: Apr. 16, 2009

(54) APPARATUS AND METHOD FOR RECEIVING MULTIPATH SIGNAL IN A WIRELESS COMMUNICATION SYSTEM

(75) Inventors: Soo-Bok YEO, Suwon-si (KR); Hun-Kee KIM, Seoul (KR); Young-Ik CHO, Seoul (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/251,381

(22) Filed: Oct. 14, 2008

(30) Foreign Application Priority Data
Oct. 16, 2007 (KR) 2007-0103906

(51) Int. Cl. H04B 1/707; H04L 27/06

(52) U.S. Cl. 375/148; 375/316; 375/E01.032

(57) ABSTRACT

An apparatus and method for receiving a multipath signal in a wireless communication system are provided. The apparatus includes a sample buffer, a buffer index controller, a finger, and a Deskewer buffer and combiner. The sample buffer stores sample data corresponding to a defined number of chips among reception data converted into digital signals. The buffer index controller controls a position of the sample buffer to store the converted data and a position of the sample buffer to output data. The finger receives sample data from a specific position of the sample buffer and demodulates each multipath signal. The Deskewer buffer and combiner eliminates a temporal retard of each demodulated multipath signal and combines the multipath signals.

### PRIORITY

This application claims the benefit under 35 U.S.C. §119(a) of a Korean patent application filed in the Korean Intellectual Property Office on Oct. 16, 2007 and assigned Serial No. 2007-103906, the entire disclosure of which is hereby incorporated by reference.

### BACKGROUND OF THE INVENTION

1. Field of the Invention

The present invention relates to an apparatus and method for receiving a multipath signal in a wireless communication system. More particularly, the present invention relates to an apparatus and method for reducing a size of a buffer when one finger is used in a rake receiver.

2. Description of the Related Art

A receiver of a wireless mobile communication system demodulates, by path, signals received through a multiple path at a different time, eliminates temporal retards from the signals, and combines the signals of respective paths with each other for decoding. A device for independently demodulating and combining the multipath signal is referred to as a rake receiver.

FIG. 1 is a block diagram illustrating a construction of a general rake receiver according to the conventional art.

Referring to FIG. 1, a conventional rake receiver includes a plurality of fingers 101, 103, and 105 for demodulating a multipath signal by path and a Deskewer buffer and combiner 111 for eliminating a temporal retard of the multipath signal demodulated by path and then combining the multipath signal. As illustrated in FIG. 1, the rake receiver allocates and uses fingers of a number corresponding to the maximum ‘N’ number of paths, that is, ‘N’ number of fingers, by performing demodulation for the maximum ‘N’ number of paths having the strongest signal intensities and combining the signals of the paths with each other.

The rake receiver having the ‘N’ number of fingers allocates the ‘N’ number of fingers to a plurality of Base Station (BS) signals for soft handover. Thus, when performing soft handover, the rake receiver may demodulate signals of a limited number of paths for one BS, resulting in deteriorated demodulation performance. However, demodulation performance can be improved by using signals forwarded from other BSs for combination. However, when demodulating a data channel not supporting soft handover, the rake receiver cannot perform a combination using signals forwarded from other BSs, thus making it difficult to overcome performance degradation caused by demodulating the signals of the paths of a limited number. Thus, the rake receiver requires a greater number of fingers in order to improve the demodulation performance. However, there is a problem with the rake receiver in that an increase in the number of fingers leads to an increase in the size of the hardware, thus causing a cost increase.

In addition, when using spatial diversity to improve demodulation performance, a rake receiver requires a number of fingers of corresponding to a multiple of a number of receive antennas. For instance, when the rake receiver uses six fingers for one receive antenna, the rake receiver uses twelve fingers when two receive antennas are used. That is, the number of fingers has a tradeoff relationship between an improvement in demodulation performance and a hardware size. Thus, the rake receiver has a problem that when demodulation performance is improved, the hardware size increases and, when the hardware size decreases, demodulation performance is deteriorated.

FIG. 2 is a block diagram illustrating a construction of a rake receiver using only one finger according to the conventional art.

Referring to FIG. 2, a rake receiver structure for receiving a multipath signal has been proposed that is implemented with only one finger 203 using an input buffer 201 for storing as much data as an amount needed to buffer the data corresponding to the multiple paths. The rake receiver using one finger buffers data through the input buffer 201, time multiplexes each multipath signal from the input buffer 201, and operates the finger at high speed by ‘N’ times of a data input speed to perform demodulation. Since the rake receiver continuously buffers data received during the data demodulation, the rake receiver can independently operate a write operation of the input buffer 201 and a read operation, and thereby eliminate a temporal retard of each multiple path by the finger 203.

However, a method using only one finger using a buffer as illustrated in FIG. 2 has a problem that the input buffer 201 greatly increases in size because of having to buffer an amount of data associated with the multipaths during an amount of time corresponding to a multipath temporal retard. In detail, in the method using the plurality of fingers of FIG. 1, the Deskewer buffer has a physical size identical with a value of a multiplication of all the maximum allowable multipath temporal retard, maximum number of symbols per chip, I/Q data, and number of bits per symbol. In the method using the one finger of FIG. 2, the input buffer has a physical size identical with a value of a multiplication of all the maximum allowable multipath temporal retard, number of samples per chip, I/Q data, number of bits per sample, and number of antennas. Thus, the buffer size required in the method using the one finger is larger by several times or dozens of times than the buffer size required in the method using the plurality of fingers.

Thus, the method using the input buffer has a benefit in that it reduces a hardware requirement by reducing the number of fingers to one. However, there is a problem in that, due to an increase of a buffer size, the benefit is mitigated.

Accordingly, there is a need to provide a multipath reception method in which the rake receiver uses only one finger while reducing a degree of an increase of the hardware size caused by the buffer.

### SUMMARY OF THE INVENTION

An aspect of the present invention is to address at least the above-mentioned problems and/or disadvantages and to provide at least the advantages described below. Accordingly, one aspect of the present invention is to provide an apparatus and method for receiving a multipath signal in a wireless communication system.

Another aspect of the present invention is to provide an apparatus and method for reducing a size of a buffer when one finger is used in a rake receiver of a wireless communication system.

A further aspect of the present invention is to provide an apparatus and method for demodulating data using a buffer storing a chip received and a buffer for extracting an exact sample in a rake receiver with one finger.

Still another aspect of the present invention is to provide an apparatus and method for adjusting the execution or non-execution of a demodulation operation and number of times of execution depending on a change of a sample offset, and demodulating data in a rake receiver of a wireless communication system.

The above aspects are addressed by providing an apparatus and method for receiving a multipath signal in a wireless communication system.

According to one aspect of the present invention, an apparatus for receiving a multipath signal in a wireless communication system is provided. The apparatus includes a sample buffer, a buffer index controller, a finger, and a Deskewer buffer and combiner. The sample buffer stores sample data corresponding to a defined number of chips among reception data that is converted into digital signals. The buffer index controller controls a position of the sample buffer to store the converted data and a position of the sample buffer to output data. The finger receives sample data from a specific position of the sample buffer and demodulates each multipath signal under control of the buffer index controller. The Deskewer buffer and combiner eliminates a temporal retard of each multipath signal demodulated in the finger and combines the multipath signals.

According to another aspect of the present invention, a method for receiving a multipath signal in a wireless communication system is provided. The method includes reading an on-sample for each multiple path and an early-sample and late-sample corresponding to the on-sample from a sample buffer for storing sample data corresponding to a defined number of chips, calculating a sample offset adjustment value, upon updating the sample offset adjustment value, acquiring a current sample offset using the sample offset adjustment value, determining if there is an on-sample for a corresponding path at a corresponding chip clock depending on a previous sample offset and the sample offset adjustment value, and determining one of execution and non-execution of a demodulation operation and number of times of execution depending on the determination.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following detailed description taken in conjunction with the accompanying drawings, in which:

FIG. 1 is a block diagram illustrating a construction of a general rake receiver according to the conventional art;

FIG. 2 is a block diagram illustrating a construction of a rake receiver using only one finger according to the conventional art;

FIG. 3 is a block diagram illustrating a construction of a rake receiver according to an exemplary embodiment of the present invention;

FIG. 4 is a diagram illustrating an operational state of a sample buffer according to an exemplary embodiment of the present invention;

FIG. 5 is a diagram illustrating an operational state of a sample buffer when a sample offset is retarded in a rake receiver according to an exemplary embodiment of the present invention;

FIG. 6 is a diagram illustrating an operational state of a sample buffer when a sample offset is retarded in a rake receiver according to another exemplary embodiment of the present invention;

FIG. 7 is a diagram illustrating an operational state of a sample buffer when a sample offset is advanced in a rake receiver according to an exemplary embodiment of the present invention;

FIG. 8 is a diagram illustrating an operational state of a sample buffer when a sample offset is advanced in a rake receiver according to another exemplary embodiment of the present invention; and

FIG. 9 is a flow diagram illustrating a process of data demodulation depending on a retard or advance of a sample offset in a rake receiver according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

It is to be understood that the singular forms “a,” “an,” and “the” include plural referents unless the context clearly dictates otherwise. Thus, for example, reference to “a component surface” includes reference to one or more of such surfaces.

As used herein, the term “about” means that dimensions, sizes, formulations, parameters, shapes and other quantities and characteristics are not and need not be exact, but may be approximated and/or larger or smaller, as desired, reflecting tolerances, conversion factors, rounding off, measurement error and the like and other factors known to those of skill in the art.

An apparatus and method for reducing a size of a buffer when one finger is used in a rake receiver of a wireless communication system according to exemplary embodiments of the present invention are described below in detail. In the following description, a chip represents data obtained by spreading a modulation symbol by a Spreading Factor (SF), and sample data represents data over-sampled at a speed of 8 times of the chip.

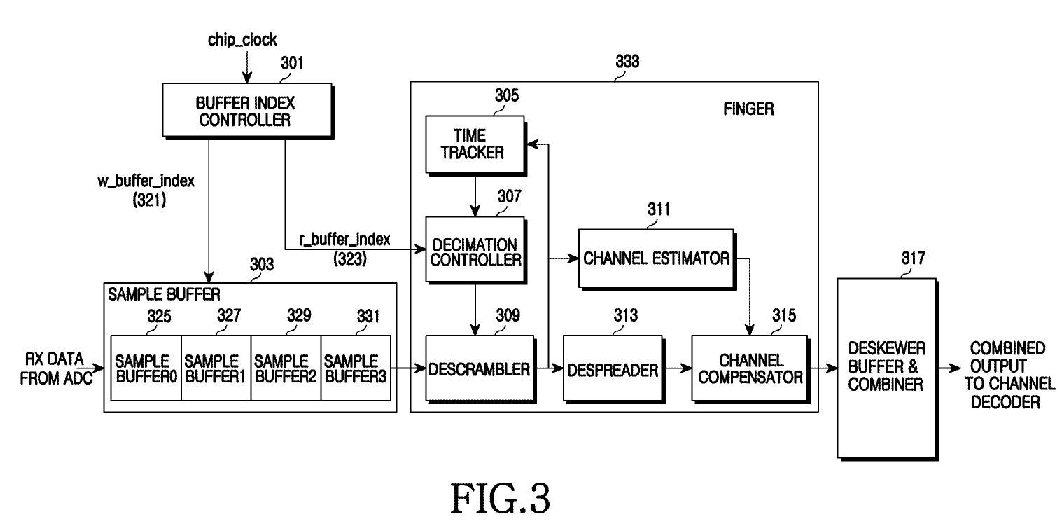

FIG. 3 is a block diagram illustrating a construction of a rake receiver according to an exemplary embodiment of the present invention. Referring to FIG. 3, the rake receiver includes a buffer index controller 301, a sample buffer 303, a finger 333, and a Deskewer buffer and combiner 317. The finger 333 includes a time tracker 305, a decimation controller 307, a descrambler 309, a channel estimator 311, a despreader 313, and a channel compensator 315.

The buffer index controller 301 controls an index of a sample buffer to buffer reception data, that is, data output from an Analog-to-Digital Converter (ADC) every chip clock (chip_clock), and controls an index of a sample buffer to extract an on-sample designated by the time tracker 305. That is, the buffer index controller 301 outputs a write buffer index (w_buffer_index) 321 and a read buffer index (r_buffer_index) 323. The write buffer index (w_buffer_index) 321 represents an index of a sample buffer to store data from the ADC, and the read buffer index (r_buffer_index) 323 represents an index of a sample buffer to provide data to the descrambler 309 of the finger 333. The write buffer index 321 increases by ‘1’ every generation of a chip clock (chip_clock), and can have a values of 0, 1, 2, or 3 through a modulo-4 operation. Here, the chip clock is not a value related to a finger having several multiple retards but instead is a signal synchronized to a frame border managed in the receiver. In a terminal for example, the chip clock refers to a signal synchronized to a border of a frame transmitted by the terminal. The read buffer index 323 can be acquired by carrying out a modulo-4 operation based on the write buffer index 321. That is, the write buffer index 321 is equal to a result of adding ‘2’ to the read buffer index 323 and then carrying out a modulo-4 operation.

The sample buffer 303 stores a sample while a defined number of chips are received. The sample buffer 303 includes a defined number of sample buffers and is of a circular form. In an exemplary embodiment of the present invention, for example, the sample buffer 303 stores a sample during four chips and includes four sub buffers (i.e., a sample buffer0 325, a sample buffer1 327, a sample buffer2 329, and a sample buffer3 331). The sample buffer 303 is designated by the write buffer index 321 or read buffer index 323 output from the buffer index controller 301. Depending on the designated index 321 or 323, the sample buffer 303 stores data received from the ADC or outputs stored data to the finger 333.

In the sample buffer 303, the sub buffers (i.e., the sample buffer0 325, sample buffer1 327, sample buffer2 329, and sample buffer3 331) each have a space for storing eight samples. The sub buffers 325, 327, 329, and 331 each can be physically realized by independent memory segments or can be logically divided and realized in one memory segment. That is, the sub buffers 325, 327, 329, and 331 can be logically divided and realized by an address in one memory segment having a space for storing 32 samples. In an exemplary embodiment of the present invention, for example, each sub buffer of the sample buffer 303 is separated from one large memory segment by a logical address.

The finger 333 may operate at high speed or may operate in a pipe-lined form. The finger 333 demodulates a signal for each user, performs channel estimation and compensation, and outputs the result to the Deskewer_buffer and combiner 317.

With reference to the read buffer index 323 of the buffer index controller 301, the time tracker 305 reads an m^{th} on-sample for an n^{th} multiple path and an early-sample and late-sample for the on-sample and then, searches for a position of the on-sample using an energy difference of a symbol restored from the early-sample and late-sample. More specifically, the time tracker 305 calculates a change of a sample offset by path (i.e., a sample offset adjustment value) using the early-sample and late-sample for the on-sample, and outputs the calculated sample offset adjustment value to the decimation controller 307. The early-sample or late-sample is a sample advanced or retarded by a ½ chip (i.e., four samples) compared to the on-sample.

The decimation controller 307 receives a read buffer index 323, an index of a sample buffer to extract an on-sample, from the buffer index controller 301, receives a sample offset adjustment value from the time tracker 305, calculates a sample offset representing a position of the on-sample, and provides the calculated sample offset to the descrambler 309. The decimation controller 307 controls the execution or non-execution of a demodulation operation of the finger 333 or number of times of execution at a current chip clock depending on the calculated sample offset value. For example, the decimation controller 307 controls the finger not to execute the demodulation operation or controls the finger to repeat the execution the demodulation operation at a current chip clock depending on the calculated sample offset value. The demodulation operation represents a descrambling and despreading operation executed for every chip.

The descrambler 309 and despreader 313 perform a descrambling and despreading operation under the control of the decimation controller 307.

The channel estimator 311 estimates a current channel state using a pilot channel. The channel compensator 315 performs channel compensation for an input signal using the channel estimation result and then, outputs the compensation result to the Deskewer buffer and combiner 317.

The Deskewer buffer and combiner 317 eliminates a temporal retard of each multipath signal output from the finger 333, combines the retard-eliminated multipath signals, and outputs the combination result to a channel decoder (not shown).

An exemplary operation of a rake receiver according to an operational state of a sample buffer based on the construction of FIG. 3 is described below.

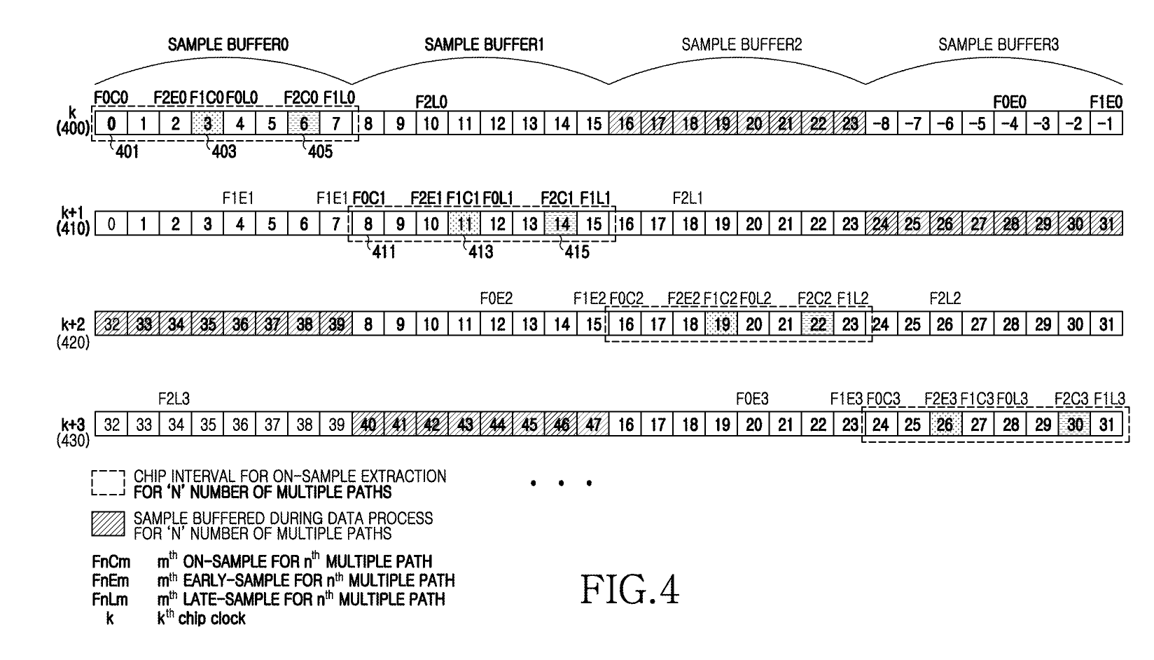

FIG. 4 is a diagram illustrating an operational state of a sample buffer according to an exemplary embodiment of the present invention.

FIG. 4 illustrates an operational state of a sample buffer according to any chip timing increasing every generation of a chip clock, that is, k^{th} chip timing 400, (k+1)^{th} chip timing 410, (k+2)^{th} chip timing 420, and (k+3)^{th} chip timing 430.

A buffer index controller 301 outputs a write buffer index 321 and a read buffer index 323 shown in Table 1 below.

TABLE 1

| | Write buffer index | Read buffer index |
|---|---|---|
| Chip timing | (w_buffer_index) | (r_buffer_index) |
| k | 2 | (2 + 2) mod 4 = 0 |
| k + 1 | 3 | (3 + 2) mod 4 = 1 |
| k + 2 | 0 | (0 + 2) mod 4 = 2 |
| k + 3 | 1 | (1 + 2) mod 4 = 3 |

Referring to FIG. 4 and Table 1, the read buffer index is equal to ‘0’ at k^{th} chip timing (400) and thus, a finger 333 extracts an on-sample of each path from a sample buffer0 325. Here, there are on-samples for ‘N’ number of multiple paths within positions of eight samples stored in the sample buffer0 325, respectively. The eight sample positions each can be marked with sample offsets of 0 to 7.

In detail, referring to FIG. 4, in the sample buffer0 325 of the k^{th} chip timing (400), there is an on-sample for path 0 in a position of a sample offset0 401, there is an on-sample for path 1 in a position of a sample offset3 403, and there is an on-sample for path 2 in a position of a sample offset6 405. The same on-samples are maintained for the next chip timing. Thus, there are the on-samples in positions of a sample offset0 411, sample offset3 413, and sample offset6 415 of a sample buffer1 327 at (k+1)^{th} chip timing (410).

The finger 333 extracts, for one time, an on-sample of each of multiple paths of the maximum ‘N’ number from the sample buffer at a speed faster by ‘N’ times than a chip speed, performs demodulation, extracts the on-sample and at the same time, extracts an early-sample and late-sample for the on-sample for use by the time tracker 305. For extracting the early-sample and late-sample, an operation of the finger 333 has to be carried out after completion of data storage in the left/right sample buffer1 327 and sample buffer3 331 storing one chip interval. For the purpose of the early-sample and late-sample, only four samples positioned left/right of the on-sample are required. However, a sample buffer for storing the early-sample and late-sample is set to 8 in size for easy description in an exemplary embodiment of the present invention.

Next, sample data is input to the receiver until the finger 333 completes an operation for the sample buffer0 325 and is stored in a sample buffer2 329 designated by the write buffer index as shown in Table 1.

In such a way, as shown in Table 1, the finger 333 changes a write buffer index and a read buffer index in a sample buffer every generation of a chip clock, while demodulating data.

A description of conditions in which a sample offset is changed by path is made below using the time tracker 305.

When a result of tracking a change of a sample offset in the time tracker 305 is the occurrence of a retard by as much as one sample, an on-sample can be searched for at a next chip timing by increasing a previous sample offset by ‘1’.

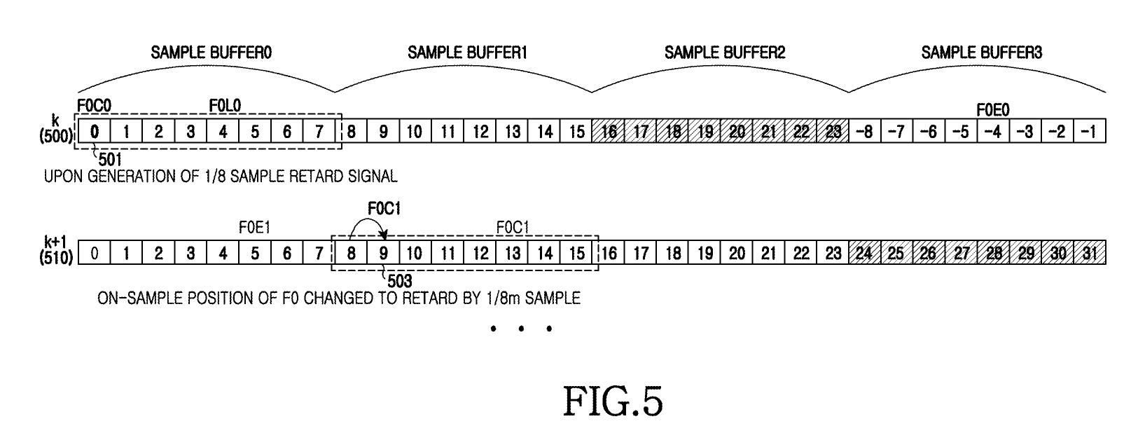

FIG. 5 is a diagram illustrating an operational state of a sample buffer when a sample offset is retarded in a rake receiver according to an exemplary embodiment of the present invention.

As illustrated in FIG. 5, when an on-sample for path 0 is positioned in a sample offset0 501 of a sample buffer0 325 at k^{th} chip timing 500, if a result of tracking a change of a sample offset is the occurrence of a retard of as much as one sample for the path 0, the sample offset0 501 of the on-sample increases by ‘1’. Thus, an on-sample is extracted as a sample positioned in a sample offset2 503 of a sample buffer 1 at (k+1)^{th} chip timing 510.

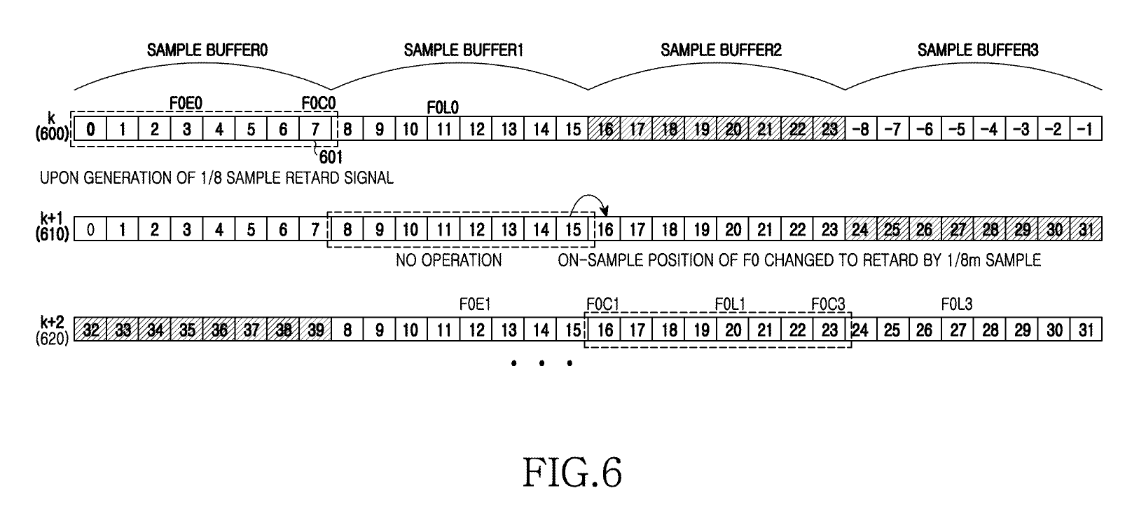

FIG. 6 is a diagram illustrating an operational state of a sample buffer when a sample offset is retarded in a rake receiver according to another exemplary embodiment of the present invention.

As illustrated in FIG. 6, when an on-sample is positioned in a sample offset7 601 of a sample buffer0 325 at k^{th} chip timing 600, if the sample offset7 601 increases by ‘1’, there is not an on-sample for a corresponding path 0 within one chip interval. Thus, there is not the on-sample for the path 0 at (k+1)^{th} chip timing 610 and there is the on-sample for the path 0 at (k+2)^{th} chip timing 620. Thus, a demodulation process for a corresponding path should be performed at (k+2)^{th} chip timing 620 and not at the (k+1)^{th} chip timing 610.

Inversely, when a result of tracking a change of a sample offset in the time tracker 305 is the occurrence of an advance by as much as one sample, generally, a previous sample offset decreases by ‘1’ and thus, an on-sample can be searched for during the next chip timing.

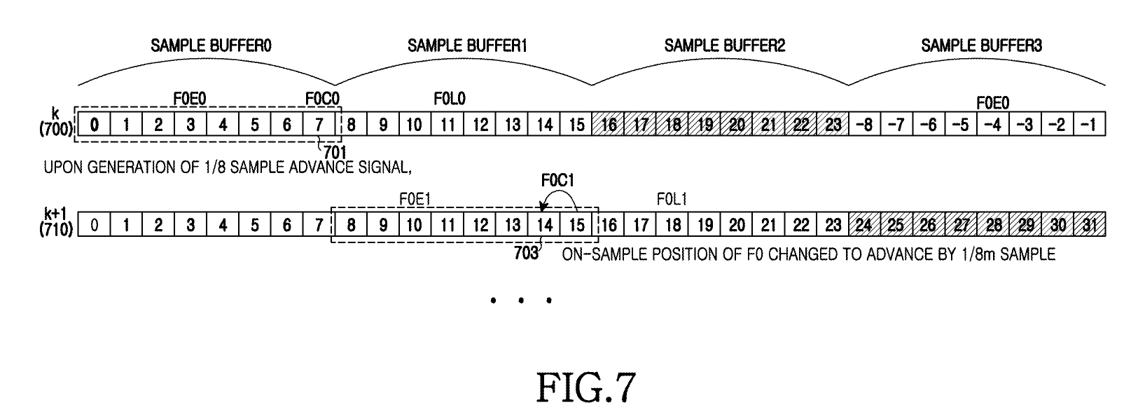

FIG. 7 is a diagram illustrating an operational state of a sample buffer when a sample offset is advanced in a rake receiver according to an exemplary embodiment of the present invention.

As illustrated in FIG. 7, when an on-sample of path 0 is positioned in a sample offset7 701 of a sample buffer0 at k^{th} chip timing 700, if a result of tracking a change of a sample offset is the occurrence of an advance by as much as one sample in the path 0, the sample offset7 701 of the on-sample decreases by ‘1’ and thus, an on-sample is extracted as a sample positioned in a sample offset6 703 of a sample buffer 1 at (k+1)^{th} chip timing 710.

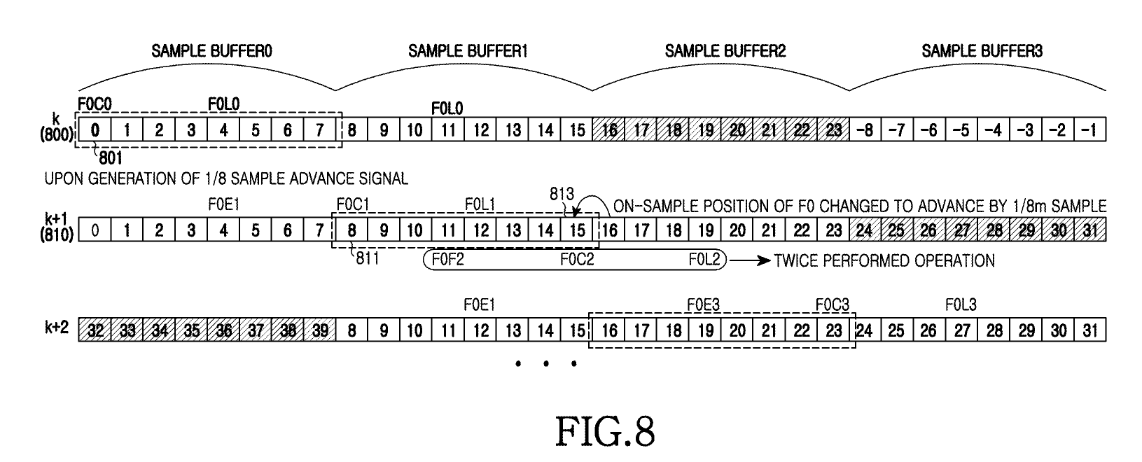

FIG. 8 is a diagram illustrating an operational state of a sample buffer when a sample offset is advanced in a rake receiver according to another exemplary embodiment of the present invention.

However, as illustrated in FIG. 8, when an on-sample is positioned in a sample offset0 801 of a sample buffer0 at k^{th} chip timing 800, if the sample offset0 801 decreases by ‘1’, there are two on-samples for a corresponding path 0 within one chip interval and thus, there are the two on-samples for the path 0 at (k+1)^{th} chip timing 810. That is, at the (k+1)^{th} chip timing 810, there are, together, an on-sample in a sample offset0 811 before generation of the sample advance and an on-sample in a sample offset7 813 after generation of the sample advance and thus, an on-sample demodulation process for a corresponding path should be performed twice.

As described above, the sample offset adjustment of the time tracker 305 can be expressed as in Equation 1 below:

New sample offset=(Previous sample offset+Sample offset adjustment value+R)mod R (1)

In Equation 1, the R denotes an oversampling rate, and is equal to ‘8’ in an exemplary embodiment of the present invention.

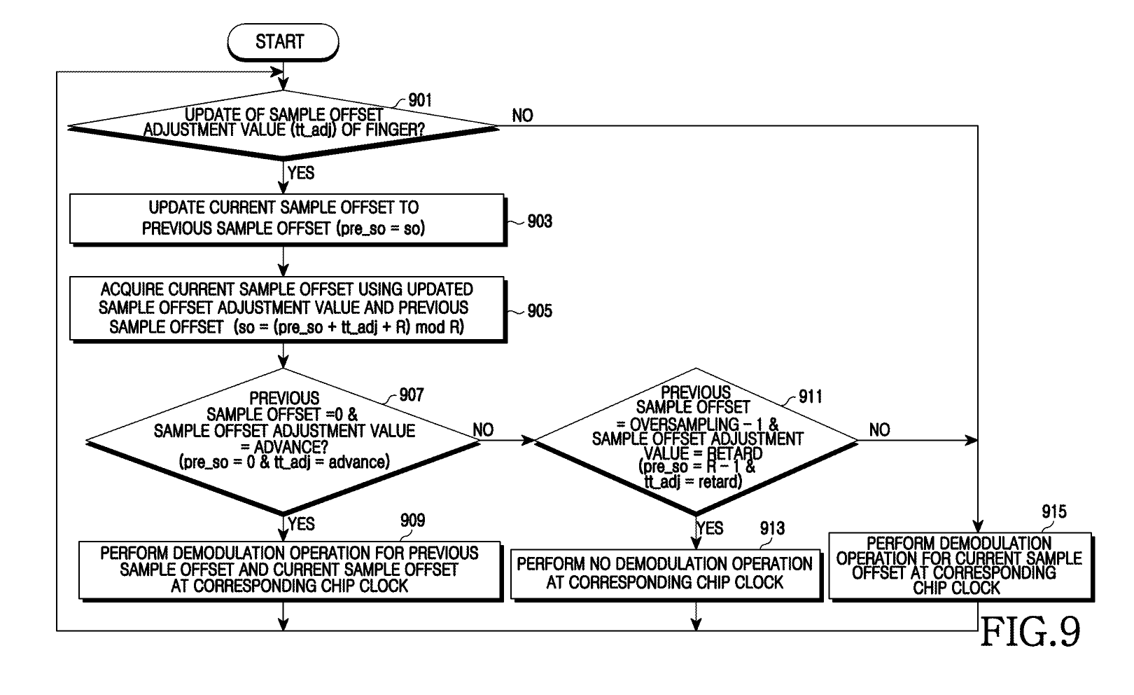

FIG. 9 is a flow diagram illustrating a process of data demodulation depending on a retard or advance of a sample offset in a rake receiver according to an exemplary embodiment of the present invention. The process described below is implemented in a finger of the rake receiver. The process is repeatedly implemented for a multiple path (N). Operation for all multiple paths should be completed within one chip time.

Referring to FIG. 9, in step 901, the finger identifies if there is an update of a sample offset adjustment value (tt-adj) for updating a sample offset that is a position of an on-sample, using the on-sample extracted from a sample buffer and its corresponding early-sample and late-sample. If there is not an update of the sample offset adjustment value, the process proceeds to step 915 described below.

If there is an update of the sample offset adjustment value, in step 903, the finger sets a current sample offset as a previous sample offset (pre_so=so) and then, in step 905, acquires a current sample offset using the updated sample offset adjustment value and the previous sample offset. The current sample offset can be acquired using Equation 1.

After that, in step 907, the finger identifies if the previous sample offset is equal to ‘0’ and the sample offset adjustment value is equal to ‘advance’. If the previous sample offset is equal to ‘0’ and the sample offset adjustment value is equal to ‘advance’, in step 909, the finger determines that there are two on-samples in a corresponding path at a corresponding chip clock, performs a demodulation operation for samples positioned in the previous sample offset and current sample offset at the corresponding chip clock, and then returns to step 901.

If the previous sample offset is equal to ‘0’ and the sample offset adjustment value is not equal to ‘advance’, or the previous sample offset is not equal to ‘0’ and the sample offset adjustment value is equal to ‘advance’, in step 911, the finger identifies if the previous sample offset is less than oversampling by ‘1’ and the sample offset adjustment value is equal to ‘retard’.

If the previous sample offset is less than the oversampling by ‘1’ and the sample offset adjustment value is equal to ‘retard’, in step 913, the finger determines that there is not an on-sample at a corresponding chip clock, controls and does not perform a demodulation operation at the corresponding chip clock, and then returns to step 901.

If the previous sample offset is not less than the oversampling by ‘1’ and the sample offset adjustment value is equal to ‘retard’, or the previous sample offset is less than the oversampling by ‘1’ and the sample offset adjustment value is not equal to ‘retard’, in step 915, the finger performs a demodulation operation for the current sample offset at a corresponding chip clock and then returns to step 901.

As described above, an exemplary embodiment of the present invention uses a sample buffer for storing sample data during four chip intervals, one finger for demodulating a multipath signal, and a Deskewer buffer and combiner for eliminating a retard in each path for combination, thereby reducing a requirement of the buffer size compared to a conventional rake receiver, giving substantial hardware savings.

The physical size of the buffer according to an exemplary embodiment of the present invention can be expressed in Equation 2 below.

L_{—}c=n*number of samples per chip*I/Q data*M*A+L_{—}a (2)

In Equation 2, the ‘L_c’ denotes a physical size of a buffer according to an exemplary embodiment of the present invention, the ‘n’ denotes chip intervals of a defined number stored in a sample buffer, the I/Q denotes In-phase and Quadrature phase (I/Q), the ‘M’ denotes a number of bits per sample, the ‘A’ denotes a number of antennas, and the ‘L_a’ denotes a physical size of a Deskewer buffer.

For instance, a value of the portion of Equation 2 that when added to ‘L_a’ equals ‘L_c’ is equal to ‘768’ when the sample buffer stores sample data of a 4-chip interval, the number of samples per chip is equal to ‘8’, the I/Q data is equal to ‘2’, the number of bits per sample is equal to ‘6’, and the number of antennas is equal to ‘2’. When a multipath retard allowed by the Deskewer buffer is equal to ‘384’ and number of bits per modulation symbol with SF=4 is equal to ‘12’, the Deskewer buffer has a size of L_a=384*¼ (maximum number of symbols per chip)*2 (I/Q data)*12 (number of bits per symbol)=2304. Thus, the buffer according to an exemplary embodiment of the present invention has a size ‘L_c’ of ‘3072’ according to Equation 2.

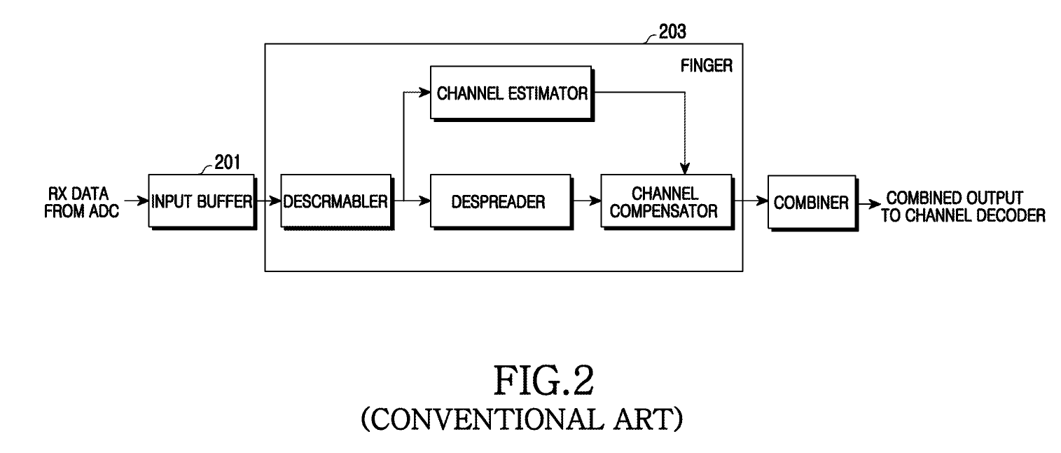

Inversely, in a method using an input buffer for storing a sample of as much as a multipath retard and one finger according to the conventional art illustrated in FIG. 2, a size of the input buffer is equal to a value of a multiplication of all the maximum allowable multipath retard, number of samples per chip, I/Q data, number of bits per sample, and number of antennas and thus, is equal to ‘73728’. This is about 24 times of a size of a sample buffer according to an exemplary embodiment of the present invention.

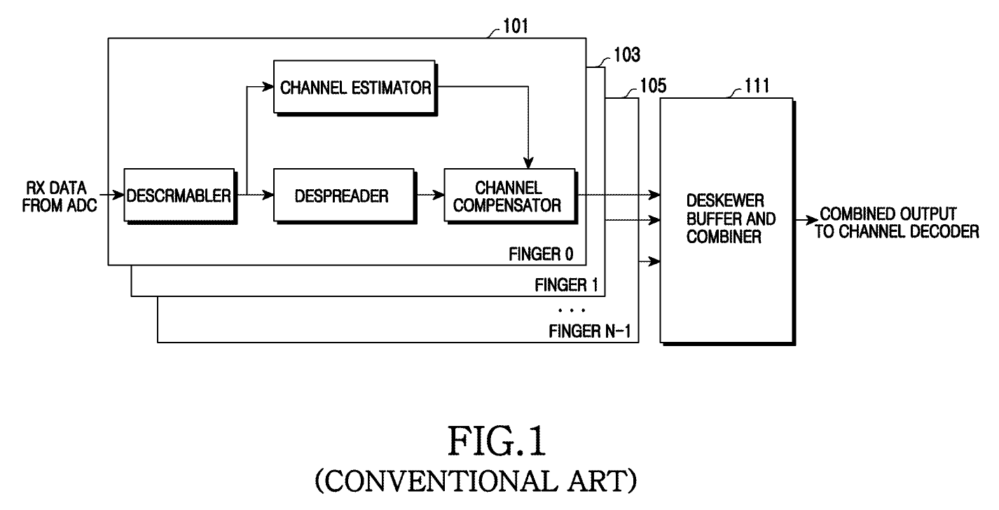

That is, an exemplary embodiment of the present invention can obtain benefit by reducing a hardware requirement by reducing number of fingers compared to a conventional rake receiver illustrated in FIG. 1, and can obtain a benefit by reducing a hardware requirement by reducing a size of a buffer compared to a conventional rake receiver illustrated in FIG. 2.

Exemplary embodiments of the present invention have an effect of being capable of reducing a size of a buffer, reducing a hardware requirement, and saving a realization cost compared to a conventional rake receiver, by changing a position of a sample buffer for storing a received chip and a position of a sample buffer for sample extraction every chip clock, storing reception data, reading and demodulating the stored data in a rake receiver including a sample buffer for storing a defined number of chips and one finger for demodulating a multipath signal.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for receiving a multipath signal in a wireless communication system, the apparatus comprising:
a sample buffer for storing sample data corresponding to a defined number of chips among reception data that is converted into digital signals;
a buffer index controller for controlling a position of the sample buffer to store the converted data and a position of the sample buffer to output data;
a finger for receiving sample data from the sample buffer and demodulating each multipath signal under control of the buffer index controller; and
a Deskewer buffer and combiner for eliminating a temporal retard of each multipath signal demodulated in the finger and combining the multipath signals.

2. The apparatus of claim 1, wherein the sample buffer is comprised of a plurality of sub buffers for storing sample data corresponding to one chip, and
wherein the sub buffers are each physically realized by independent memory segments or are logically divided and realized by an address in one memory segment.

3. The apparatus of claim 1, wherein the sample buffer comprises a space for storing a chip from the reception data, a space for extracting an on-sample, and a space for an early-sample and late-sample for the on-sample.

4. The apparatus of claim 1, wherein the buffer index controller adjusts a write buffer index representing a position of a sample buffer to store converted reception data every chip clock, and adjusts a read buffer index representing a position of a sample buffer to output data to the finger.

5. The apparatus of claim 4, wherein the write buffer index and read buffer index represent indexes of sub buffers constituting the sample buffer.

6. The apparatus of claim 4, wherein the write buffer index increases by ‘1’ every chip clock generation, and the read buffer index is acquired by carrying out a modulo operation on the basis of the write buffer index.

7. The apparatus of claim 1, wherein the one finger comprises:
a time tracker for calculating a sample offset adjustment degree of each multiple path from sample data received from a specific position of the sample buffer under control of the buffer index controller;
a decimation controller for calculating a sample offset representing a position of an on-sample that is an exact sample to be demodulated depending on the sample offset adjustment degree calculated in the time tracker, and for controlling one of execution and non-execution of a demodulation operation and a number of times of execution at a current chip clock; and
a demodulator for performing a demodulation operation under control of the decimation controller.

8. The apparatus of claim 7, wherein the time tracker calculates the sample offset adjustment degree by path from the received sample data using an energy difference of a symbol restored from an early-sample and late-sample for an on-sample of each path.

9. The apparatus of claim 7, wherein the decimation controller controls to one of perform and not perform a demodulation operation once or twice at a corresponding chip clock depending on the sample offset.

10. The apparatus of claim 7, wherein the decimation controller calculates a sample offset using an equation:
New sample offset=(Previous sample offset+Sample offset adjustment degree+R) mod R
where, R denotes an oversampling rate.

11. The apparatus of claim 7, wherein the demodulator performs descrambling and despreading for an on-sample of each path and compensates the despreaded signal through channel estimation under control of the decimation controller.

12. The apparatus of claim 1, wherein the sample buffer has a size L_c’ determined using an equation:
L_{—}c=n*number of samples per chip*I/Q data*M*A+L_{—}a
where ‘n’ denotes chip intervals of a defined number stored in a sample buffer, ‘I/Q’ denotes In-phase and Quadrature phase, ‘M’ denotes a number of bits per sample, ‘A’ denotes a number of antennas, and ‘L_a’ denotes a size of the Deskewer buffer.

13. A method for receiving a multipath signal in a wireless communication system, the method comprising:
reading an on-sample for each multiple path and an early-sample and late-sample corresponding to the on-sample from a sample buffer for storing sample data corresponding to a defined number of chips;
calculating a sample offset adjustment value;
upon updating the sample offset adjustment value, acquiring a current sample offset using the sample offset adjustment value;
determining if there is an on-sample for a corresponding path at a corresponding chip clock depending on a previous sample offset and the sample offset adjustment value; and
determining one of execution and non-execution of a demodulation operation and number of times of execution depending on the determination.

14. The method of claim 13, wherein the current sample offset is acquired using an equation:
New sample offset=(Previous sample offset+Sample offset adjustment value+R) mod R
where, R denotes an oversampling rate.

15. The method of claim 13, wherein the determining of the execution or non-execution of the demodulation operation and the number of times of execution comprises determining to execute the demodulation operation twice for two on-samples at a corresponding chip clock when a result of identifying the previous sample offset and sample offset adjustment value is that there are the two on-samples for a corresponding chip path at the corresponding chip clock.

16. The method of claim 13, wherein the determining of the one of execution and non-execution of the demodulation operation and the number of times of execution comprises determining to execute the demodulation operation once for one on-sample at a corresponding chip clock when a result of determining the previous sample offset and sample offset adjustment value is that there is the one on-sample for a corresponding chip path at the corresponding chip clock.

17. The method of claim 13, wherein the determining of the execution or non-execution of the demodulation operation and the number of times of execution comprises determining not to perform a demodulation operation for a corresponding path at a corresponding chip clock when a result of determining the previous sample offset and sample offset adjustment value is that there is no on-sample in a corresponding chip path at the corresponding chip clock.

18. The method of claim 13, wherein the sample buffer comprises a plurality of sub buffers for storing sample data corresponding to one chip, and
wherein the sub buffers are each physically realized by independent memory segments or are logically divided and realized by an address in one memory segment.

19. The method of claim 13, wherein the sample buffer is comprised of a space for storing a chip, a space for extracting an on-sample, and a space for an early-sample and late-sample for the on-sample.

20. The method of claim 13, wherein the sample buffer has a size L_c’ determined using an equation:
L_{—}c=n*number of samples per chip*I/Q data*M*A+L_{—}a
where ‘n’ denotes chip intervals of a defined number stored in a sample buffer, ‘I/Q’ denotes In-phase and Quadrature phase, ‘M’ denotes a number of bits per sample, ‘A’ denotes a number of antennas, and ‘L_a’ denotes a size of the Deskewer buffer.
